(19) United States
(12) Patent Application Publication
(10) Pub. No.: US 2002/0178402 A1
(43) Pub. Date: Nov. 28, 2002

(54) System and method for software diagnosis

(76) Inventor: Kenny Tsai, Taipei (TW)

Correspondence Address: BIRCH STEWART KOLASCH & BIRCH, PO BOX 747, FALLS CHURCH, VA, 22040-0747, US

(21) Appl. No.: 09/892,547

(22) Filed: Jun. 28, 2001

(30) Foreign Application Priority Data
Apr. 6, 2001 (TW) 90108290

(51) Int. Cl. H04B 1/74

(52) U.S. Cl. 714/38

(57) ABSTRACT

A system of software diagnosis to diagnose a un-debugged software having a plurality of program segments related to at least one event. The system is characterized in that it includes an event ratio-calculating module and an event-generating module. The event ratio-calculating module calculates the production weight of the individual event based on the ratios of the program segments in the un-debugged software and the relation of the program segments with the individual events. The event-generating module generates the individual event based on the production weight for diagnosing the un-debugged software.

### BACKGROUND OF THE INVENTION

1. Field of Invention

The invention relates to a system and method for software diagnosis, and in particular, a software diagnosis system and method which calculates the production weight of an event based on the ratio of program segments in the software and the relationship of the software segments and the event and generates the event based on the production weight.

2. Related Art

Software designers must first understand the needs of users and then proceed to the planning of the software requirements. Afterwards, the designers define the system model of the software by clearly expressing the system model in the form of a tree diagram so as to affirm the degree of influences for each function mode, function performance, data source and the safety of the various function modes. Next, the designer starts to build the main framework and the detailed design for various function modes. The main framework refers to the various function modes and the function of the interface thereof. The detailed design refers to the detail planning of each function mode. After the detailed planning is completed, the designer starts to draft the practical program code. At this time, the editing of the program code of the software has to be done based on the main framework and the various function modes established by the detailed design, so as to obtain the original requirement of the software function and the quality thereof.

After completing the program code of the software, the software needs to be diagnosed to test whether the results of the execution of the program complies with the requirements of the designer. The designer must determine whether the input and output data or each single function mode complies with the requirement. In addition, the entire performance of the system has to be tested, i.e., even if the functions comply with the requirements but the speed of execution is slow, the software is considered to have not met the needs of the users.

In the course of software coding and testing, a laborious step is the “debugging” step. The designer needs to understand every defect in the software and to find the defect in the software in the most efficient way. As a result, the software designer tests the software based on the experience of the designer with respect to the most frequently encountered defects. Thus, all the defects in the software cannot be fully diagnosed. As a result, when the designer presents the software to the user, and in the course of the user using the program, un-debugged errors that were not detected by the designer are found by the user. Additionally, if the software designer proceeds with the testing of each single function of the software, a lot of time is wasted and if every function is to be tested, it is difficult to focus on testing the important functions of the software.

In view of the above, a prime issue is the complete testing of software in the most timesaving manner, and in particular, on the complete testing of the most important functions of the software.

### SUMMARY OF THE INVENTION

Accordingly, an objective of the invention is to provide a system and a method for software diagnosis, which could automatically and fully test the software focusing on the important functions of the software.

The invention is characterized in that the system generates an event for software testing based on the ratio of a program segment in the software.

To achieve above objective, the system according to the invention is characterized in that the system includes an event ratio-calculating module and an event-generating module. The system is used to diagnose un-debugged software, and the un-debugged software includes a plurality of program segments and each program segment is related to at least one event. The event ratio-calculating module calculates the production weight of the individual event based on the ratio of the individual program segment in the un-debugged software, and the relationship of the individual event and the individual program segment. The event-generating module generates individual events based on the production weight of the individual event so as to diagnose the un-debugged software.

According to an aspect of the invention, the system further includes a diagnosis result recording module, which generates a report based on the result of the diagnosis of the un-debugged software.

Furthermore, the method according to the invention is used to test the un-debugged software including a plurality of program segments. Each program segment is related to at least one event. The method includes steps for generating the production specific weight of the individual event, diagnosing the un-debugged software, and generating a report based on the result of the diagnosis of the un-debugged software.

Since the system and method for software diagnosis according to the invention generates the events according to the production weight of the program segments, the system and method can test the software automatically and completely, and the more important a program segment is, the more events it receives. Thus, the system and method allow the software designer to save time in software testing and enables complete testing with respect to the important functions of the software.

### BRIEF DESCRIPTION OF THE DRAWINGS

The invention will become more fully understood from the detailed description given hereinbelow illustration only, and thus are not limitative of the invention, and wherein:

FIG. 1 is a schematic view showing the system for software diagnosis according to the preferred embodiment of the invention.

FIG. 2 is a schematic view showing the analysis result of the production weights of the events.

FIG. 3 is a flowchart showing the method for software diagnosis according to the preferred embodiment of this invention.

### DETAILED DESCRIPTION OF THE INVENTION

The invention will be apparent from the following detailed description, which proceeds with reference to the accompanying drawings, wherein the same references relate to the same elements.

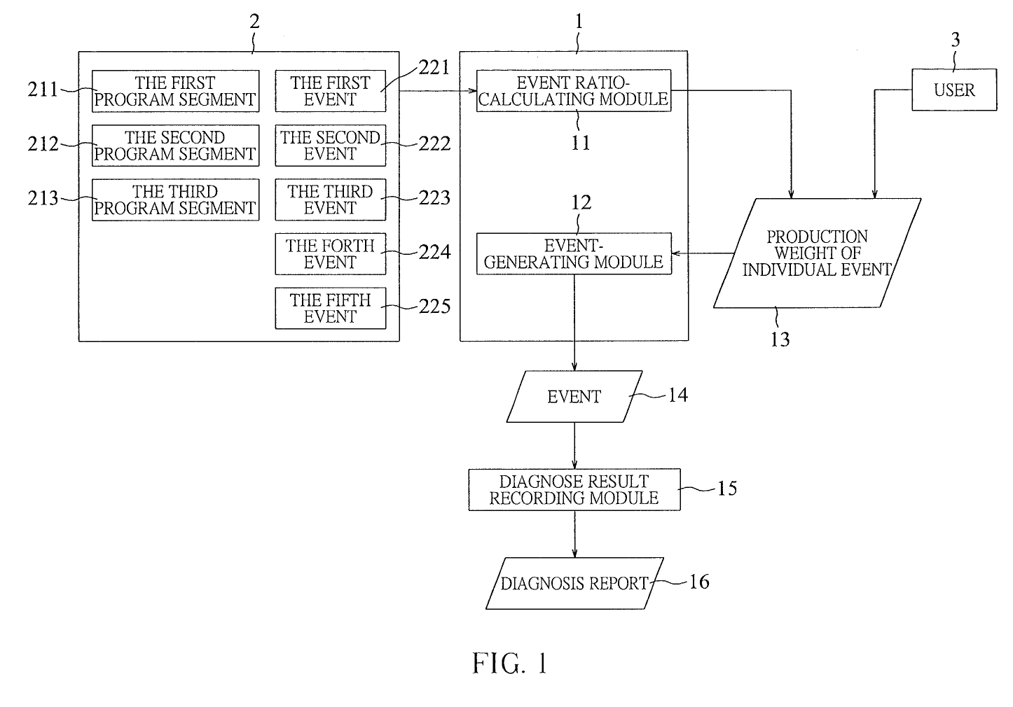

Referring to FIG. 1, a system 1 for software diagnosis of a preferred embodiment of the invention including an event ratio-calculating module 11, and an event-generating module 12. The system 1 is used to diagnose un-debugged software 2, and the un-debugged software 2 includes a first program segment 211, a second program segment 212, and a third program segment 213, wherein the respective program segments are related to at least one of a first event 221, a second event 222, a third event 223, a forth event 224, and a fifth event 225.

In the preferred embodiment, the event ratio-calculating module 11 calculates a production weight 13 of each event based on the ratio of each program segment in the un-debugged software and the relation of each program segment and each event. Then the event-generating module 12 having generating each event to diagnose the un-debugged software 11 based on the production weight 13 of each event.

In the preferred embodiment, the event ratio-calculating module 11 automatically produces the ratio of the individual program segment in the un-debugged software 2 and the ratio of the individual event in the related program segment is automatically produced by the event ratio-calculating module 11 so as to calculate the production weight 13 of the individual event. Alternatively, the ratio of the program segment in the un-debugged software 2 and the ratio of the event in the related program segment can not only be automatically produced by the event ratio-calculating module 11, but can also be produced by manual input of the user 3.

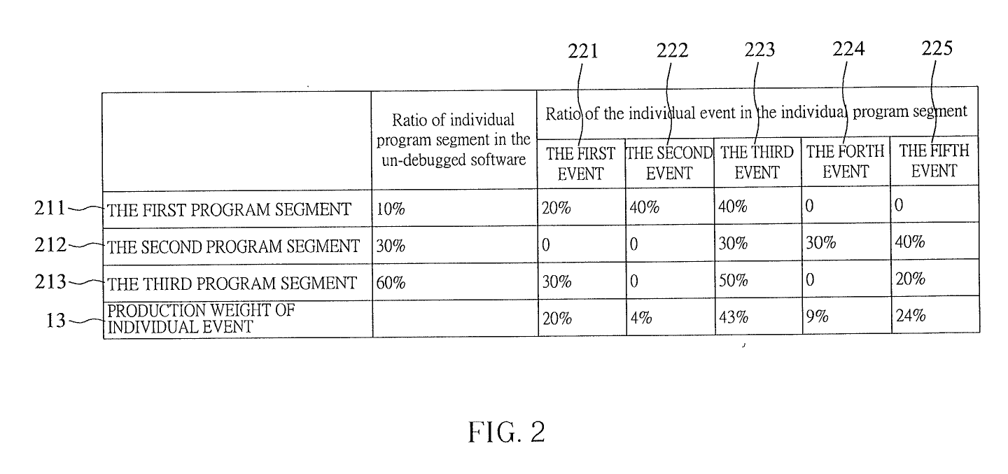

For instance, as shown in FIG. 2, the ratios of the first program segment 211, the second program segment 212, and the third program segment 213 in the un-debugged software 2 are respectively 10%, 30%, and 60%. The first program segment 211 is related to the first event 221, the second event 222, and the third event 223. The ratios of the first event 221, the second event 222, and the third event 223 in the first program segment 211 are respectively 20%, 40%, and 40%. The second program segment 212 is related to the third event 223, the forth event 224, and the first event 225. The ratios of the third event 223, the forth event 224, and the fifth event 225 in the second program segment 212 are respectively 30%, 30%, and 40%. The third program segment is related to the first event 221, the third event 223, and the first event 225. The ratios of the first event 221, the third event 223, and the fifth event 225 in the second program segment 212 are respectively 30%, 50%, and 20%. Accordingly, the event ratio-calculating module 11 generates the production weight 13 of the individual event for the un-debugged software 2 based on the above data as follows: the first event 221 is 20%, the second event 222 is 4%, the third event 223 is 43%, the forth event 224 is 9%, and the fifth event 225 is 24%.

Thereafter, the event-generating module 12, based on the production weight 13 of the individual event, randomly select an event 14 from the event sets of first event 221 to the fifth event 225 to test the un-debugged software 2.

In the preferred embodiment, the un-debugged software 2 is applied on an operating system simulator. In addition, the system 1 of the preferred embodiment further includes a diagnosis result recording module 15. The diagnosis result recording module 15 generates a diagnosis report based on the diagnostic result of the un-debugged software 2.

In order to explain clearly the preferred embodiment, a personal digital assistant (PDA) is used to proceed with the software diagnosis method.

For testing PDA application program on a PC, the user must first install a PDA simulator on the PC operating system. This is the earlier mentioned operating system simulator. The PDA simulator simulates the hardware circuit and operating system of the exact PDA by software. The user can load PDA application software into the PDA simulator and use a mouse to give movement to the PDA simulator i.e., scroll-repeat, scroll-exist, pen-down, pen-up, and pen-move. These movements are all different events. The PDA simulator will simulate the reaction of the PDA application software with respect to these events, and the result will be displayed on the monitor of the PC. In the preferred embodiment, the so-called PDA application software is referred to the un-debugged software.

As mentioned above, the individual program segment in the un-debugged software is related to the different events. That is, different software segments will respond to different events. For instance, if the simulated code of the “Function 1” program segment of the PDA application software is:

Function 1 (event)
{

if (event mode is pen-down event),

proceed A ;

if (event mode is pen-move event),

proceed B;

if (event mode is pen-up event),

proceed C;

}

Then, the “Function 1” program segment is only related to the pen-down, pen-move and pen-up event. If the simulation code of the “Function 2” program segment of the PDA application software is:

Function 2 (event)
{

if (event mode is scroll-repeat event)

proceed D;

if (event mode is scroll-exit event)

proceed B;

}

Then, the “Function 2” program segment is only related to the scroll-repeat and scroll-exit.

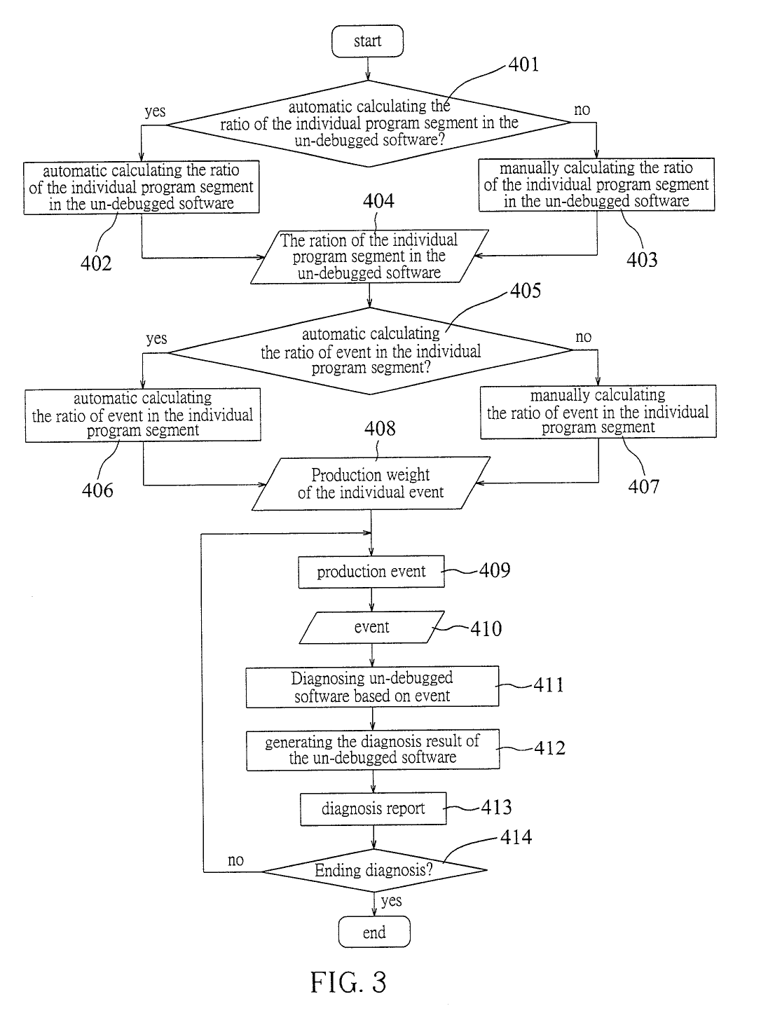

After the relationship of the individual program segments and the events are confirmed, distribute the weight based on the importance of the individual program segments in the entire PDA application program and the importance of the individual events in the individual program segments. Referring to FIG. 3, the method 4 for software diagnosis first determines in step 401 whether to automatically calculate the ratio 404 of the individual program segment in the un-debugged software 2 by step 402 or to manually calculate the ratio 404 of the individual program segments in the un-debugged software 2 by step 403. Next, in step 405, the method 4 determines whether to automatically calculate the production weight 408 of the individual event based on step 406 or to manually calculate the production weight 408 of the individual events based on step 407.

In the embodiment, if the individual weight distribution is done manually in step 403 and step 407, the user can input the weight of the individual program segment and the weight of the event in the individual software segment via a user interface. If the individual weight is calculated automatically in step 402 and step 406, the individual weight is determined based on the number of times of appearing of the individual program segment in the entire PDA application software and the number of times of the application of the individual related event in the individual program segment.

Step 409 produces event 410 based on the production weight 408 of the individual event. Next, step 411 diagnoses the un-debugged software 2 based on the event 410. As mentioned above, due to the fact that the PDA application software is loaded to the PDA simulator of the operating system of a PC, therefore step 409 generates various events via the PDA simulator by the PC based on the production weight 408. Taking the “pen-down” as an example, under general conditions, the user uses a mouse to click the PDA simulator screen to simulate the user processing a pen-down event on a PDA screen. When the PC has received the selection of the user with the mouse, this action is converted into a event of the PDA simulator. Step 409 based on production weight 408 employs the same principle to automatically generate the events of pen-move, pen-up, etc., so that the PDA application program can be tested by those events.

In addition, the method 4 further includes step 412 to generate a diagnosis result of the un-debugged software 2, and to produce a diagnosis report 413 based on the diagnosis result of the un-debugged software 2. The diagnosis report can be a text file stored in a data storage device of the PC and can be generated by the pre-inserted error-detection code of the PDA application software. This is obvious art to those skilled in the art.

In view of the above, the system and method for software diagnosis according to the invention produce events for software testing based on the ratios of the individual program segments of the un-debugged software in the software, and the ratios of the events in the individual program segments. The software can be automatically and fully diagnosed, and to focus diagnosis on the important functions of the software based on the ratios of the individual program segments in the software. Thus, the software designer can save time in software testing so as to effectively and systematically diagnose software.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

What is claimed is:

1. A system for software diagnosis, which diagnoses an un-debugged software having a plurality of program segments related to at least one event, comprising:
an event ratio-calculating module, which is used to calculate a production weight of the event based on the ratios of the
program segments in the un-debugged software and the relation of the program segments with the event; and
an event-generating module, which is used to generate the event based on the production weight for diagnosing the un-debugged software.

2. A system for software diagnosis of claim 1, wherein the ratios of the program segments in the software are automatically determined and generated by the event ratio-calculating module.

3. A system for software diagnosis of claim 1, wherein the ratios of the program segments in the software are determined and input by a user.

4. A system for software diagnosis of claim 1, wherein the event ratio further considers the ratio of the event in the related program segments while calculating module calculates the production weight of the event.

5. A system for software diagnosis of claim 4, wherein the ratio of the event in the related program segments is automatically determined and generated by the event ratio-calculating module.

6. A system for software diagnosis of claim 4, wherein the ratio of the event in the related program segments is determined and input by a user.

7. A system for software diagnosis of claim 1, wherein the un-debugged software is applied on an operating system simulator.

8. A system for software diagnosis of claim 1, wherein the event-generating module randomly selects, based on the production weight of the event, one event from a set of events.

9. A system for software diagnosis of claim 1, further comprising:
a diagnosis result recording module, which generates a diagnosis report based on the diagnosis result of the un-debugged software.

10. A method for software diagnosis, which diagnoses an un-debugged software having a plurality of program segments related to at least one event, comprising:
calculating a production weight of the event based on the ratios of the program segments in the un-debugged software and the relation of the program segments with the event; and
generating the event based on the production weight for diagnosing the un-debugged software.

11. A method for software diagnosis of claim 10, wherein the ratios of the program segments in the software are automatically determined and generated by an event ratio-calculating module.

12. A method for software diagnosis of claim 10, wherein the ratios of the program segments in the software are determined and input by a user.

13. A method for software diagnosis of claim 10, wherein when calculating the production weight of the event, the ratio of the event in the related program segments is further considered.

14. A method for software diagnosis of claim 13, wherein the ratio of the event in the related program segments is automatically determined and generated by an event ratio-calculating module.

15. A method for software diagnosis of claim 13, wherein the ratio of the event in the related program segments is determined and input by a user.

16. A method for software diagnosis of claim 10, wherein the un-debugged software is applied on an operating system simulator.

17. A method for software diagnosis of claim 10, wherein the event is randomly selected from a set of events based on the production weight of the event.

18. A method for software diagnosis of claim 10, further comprising:
generating a diagnosis report based on the diagnose result of the un-debugged software.
